(19) United States
(12) Patent Application Publication
(10) Pub. No.: US 2013/0290731 A1
(43) Pub. Date: Oct. 31, 2013

(54) SYSTEMS AND METHODS FOR STORING AND VERIFYING SECURITY INFORMATION

(71) Applicant: Paul K. BRANTON, Rochdale (GB)

(72) Inventor: Paul K. BRANTON, Rochdale (GB)

(73) Assignee: APPSENSE LIMITED, Warrington (GB)

(21) Appl. No.: 13/456,587

(22) Filed: Apr. 26, 2012

(51) Int. Cl. H04L 9/00

(52) U.S. Cl. 713/189

(57) ABSTRACT

Systems and methods are provided for storing and verifying security information. A method can include receiving a request to access an encrypted file from a storage medium, wherein the request includes security information, performing key stretching on the security information to compute a key associated with the security information, computing a first check value associated with the key, receiving at least one of a header, metadata, or filename of the encrypted file from the storage medium, retrieving a second check value stored in the at least one of the header, metadata, or filename of the encrypted file, comparing the first check value with the second check value, and receiving the encrypted file from the storage medium only when the first check value matches the second check value.

### CROSS-REFERENCE TO RELATED APPLICATION

This application is related to a co-pending U.S. patent applications Ser. No. ______, entitled “SYSTEMS AND METHODS FOR STORING AND VERIFYING SECURITY INFORMATION,” filed on even date herewith. This application is also related to two other co-pending U.S. patent applications Ser. Nos. ______, entitled “SYSTEMS AND METHODS FOR CACHING SECURITY INFORMATION,” filed on even date herewith. This application is also related to another two co-pending U.S. patent applications Ser. Nos. ______, entitled “SYSTEMS AND METHODS FOR DATA ACCESS PROTECTION,” filed on even date herewith. All aforementioned applications are expressly hereby incorporated by reference herein in their entirety.

### BACKGROUND

1. Technical Field

Disclosed systems and methods relate generally to providing security measures in computing systems or networks and, more particularly, to storing and verifying security information.

2. Description of the Related Art

Security is an important problem in modern computing systems, especially with the advent of cloud computing. Oftentimes, computer systems protect data access using an encryption mechanism. An encryption mechanism encrypts data with an encryption key so that the encrypted data cannot be retrieved or accessed without a decryption key. If the encryption mechanism is asymmetric, the encryption key is distinct from the decryption key; if the encryption mechanism is symmetric, the encryption key is identical to the decryption key. One common security measure of protecting data, files, or resources against unauthorized access is by associating the data, files, or resources with some form(s) of security information (e.g., a password or a passphrase). One of the popular encryption mechanisms is based on passphrases. A passphrase-based encryption mechanism is a symmetric encryption mechanism that uses a passphrase as both the encryption key and the decryption key. A file can be encrypted using a passphrase, and the encrypted file can be decrypted using the same passphrase. This way, the file can only be decrypted by a party with the correct passphrase.

In the past, the passphrase-based protection worked reasonably well because it was challenging for an unauthorized party to determine the correct passphrase. To an unauthorized party, guessing the correct passphrase from all possible passphrases was not an easy task. Furthermore, trying every candidate passphrase until the computing system grants data access usually required too much computation, and thus, computing time. As the computing technology advanced, however, the speed of computing systems has improved drastically. The improved computing systems provided an unauthorized party the ability to try every candidate passphrase in a reasonable amount of time. Therefore, there is a need in the art to provide systems and methods for improving passphrase-based data protection.

### SUMMARY

In accordance with the disclosed subject matter, systems and methods are provided for storing and verifying security information in computing systems or networks.

Disclosed subject matter includes, in one aspect, a method which includes receiving a request to access an encrypted file from a storage medium, wherein the request includes security information, performing key stretching on the security information to compute a key associated with the security information, computing a first check value associated with the key, receiving at least one of a header, metadata, or filename of the encrypted file from the storage medium, retrieving a second check value stored in the at least one of the header, metadata, or filename of the encrypted file, comparing the first check value with the second check value, and receiving the encrypted file from the storage medium only when the first check value matches the second check value.

In some embodiments, the security information is a passphrase. In some other embodiments, the method further includes adding a salt to the security information and performing the key stretching on the security information and the salt to compute the key associated with the security information. In some other embodiments, the method further includes adding a salt to the key to compute the first check value associated with the key. In some other embodiments, the second check value stored in the filename of the encrypted file is an ASCII representation of the second check value.

Disclosed subject matter includes, in another aspect, an apparatus which includes a processor and a memory, wherein the processor is configured to execute a module in the memory to: receive a request to access an encrypted file from a storage medium, wherein the request includes security information, perform key stretching on the security information to compute a key associated with the security information, compute a first check value associated with the key, receive at least one of a header, metadata, or filename of the encrypted file from the storage medium, retrieve a second check value stored in the at least one of the header, metadata, or filename of the encrypted file, compare the first check value with the second check value, and receive the encrypted file from the storage medium only when the first check value matches the second check value.

In some embodiments, the security information is a passphrase. In some other embodiments, the processor is configured to execute the module in the memory further to: add a salt to the security information and perform the key stretching on the security information and the salt to compute the key associated with the security information. In some other embodiments, the processor is configured to execute the module in the memory further to: add a salt to the key to compute the first check value associated with the key. In some other embodiments, the second check value stored in the filename of the encrypted file is an ASCII representation of the second check value.

Disclosed subject matter includes, in yet another aspect, a non-transitory computer readable medium which has executable instructions operable to cause an apparatus to: receive a request to access an encrypted file from a storage medium, wherein the request includes security information, perform key stretching on the security information to compute a key associated with the security information, compute a first check value associated with the key, receive at least one of a header, metadata, or filename of the encrypted file from the storage medium, retrieve a second check value stored in the at least one of the header, metadata, or filename of the encrypted file, compare the first check value with the second check value, and receive the encrypted file from the storage medium only when the first check value matches the second check value.

In some embodiments, the security information is a passphrase. In some other embodiments, the executable instructions are further operable to cause the apparatus to: add a salt to the security information and perform the key stretching on the security information and the salt to compute the key associated with the security information. In some other embodiments, the executable instructions are further operable to cause the apparatus to: add a salt to the key to compute the first check value associated with the key. In some other embodiments, the second check value stored in the filename of the encrypted file is an ASCII representation of the second check value.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A-1C illustrate passphrase enhancement methods in accordance with certain embodiments of the disclosed subject matter.

FIG. 2 illustrates a diagram of a networked communication arrangement in accordance with certain embodiments of the disclosed subject matter.

FIG. 3 illustrates a block diagram of a security information storage and verification system in accordance with certain embodiments of the disclosed subject matter.

FIGS. 4A-4B illustrate the storage of check values in accordance with certain embodiments of the disclosed subject matter.

FIG. 5 illustrates the storage of a representation of a check value in an identification of a file in accordance with certain embodiments of the disclosed subject matter.

FIG. 6 illustrates one process of storing and verifying security information in accordance with certain embodiments of the disclosed subject matter.

FIG. 7 illustrates another process of storing and verifying security information in accordance with certain embodiments of the disclosed subject matter.

FIG. 8 illustrates a block diagram of a computing system in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are only for examples, and that it is contemplated that there are other systems and methods that are within the scope of the disclosed subject matter.

Protecting secure access to data, files, or resources is an important problem in modern computing systems because data, files, or resources can be easily reached via communication networks. Unless access is adequately controlled, confidential information could be compromised in a matter of seconds. One of the popular encryption mechanisms is based on passphrases. A passphrase-based encryption mechanism is a symmetric encryption mechanism that uses a passphrase for both encryption and decryption. A file can be encrypted using a passphrase, and the encrypted file can be decrypted using the same passphrase. This way, the file can only be decrypted by a party with the correct passphrase.

Passphrase-based encryption mechanisms have worked reasonably well in the past because it was generally challenging to identify or guess the correct passphrase within a reasonable period of time. As the computation power of computer systems improves over time, however, traditional passphrase-based encryption mechanisms become more and more vulnerable to brute force attacks (i.e., a hacker tries different variations of passphrase to guess the correct passphrase).

Security of passphrase-based encryption mechanisms can be improved through passphrase enhancement. A passphrase enhancement relates to improving an original passphrase so that the modified or enhanced passphrase is harder to identify by a brute force approach. For example, when a user provides a passphrase (e.g., “MyPassword”) to a computing system, the computing system modifies the passphrase such that the enhanced passphrase (e.g., “KLJH\textcircled{}*%*&̂˜!@908”) is more complex than the original passphrase. Subsequently, the computing system would use the enhanced passphrase to encrypt and decrypt files. Because the passphrases can be enhanced behind the scenes, the passphrase enhancement can be transparent at least to authorized users.

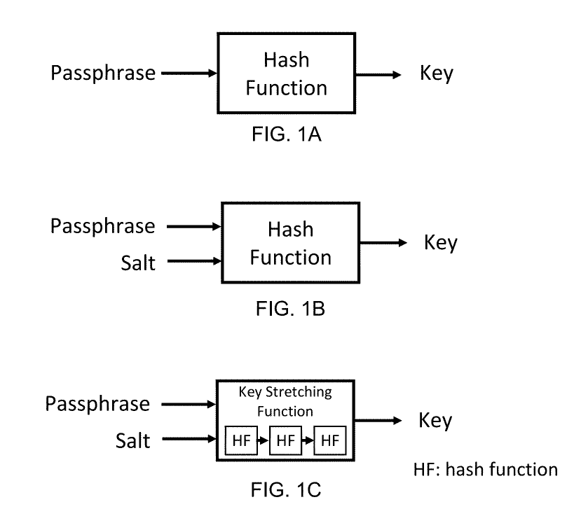

For example, a passphrase can be enhanced using a hash function. A hash function is generally a routine that maps a variable length input to a fixed length output. Examples of a hash function can include a MD2 Message-Digest Algorithm, a MD5 Message-Digest Algorithm, and a Secure Hash Algorithm. As illustrated in FIG. 1A in accordance with certain embodiments, a hash function can take an original passphrase as an input and generate a hash as an output. The output hash can serve as an enhanced passphrase. An enhanced passphrase is sometimes called a key, which is usually a very large number that is extremely difficult to guess. The key can then be used for encrypting/decrypting a target file, data, or resource. Because the enhanced passphrase (i.e., the key) can be significantly more complicated than the original passphrase, it can be significantly harder for a third party to identify the enhanced passphrase by a brute force approach. In most cases, the only reasonable way to breach the encryption mechanism with an enhanced passphrase is to identify the original passphrase and its hash function. If the passphrase-enhancing mechanism (e.g., the hash function) is known, a third party can pre-generate a set of enhanced passphrases based on various hypothetical original passphrases (e.g., all the words in an English dictionary), then use this pre-generated set of enhanced passphrases in a brute force attack. These pre-generated sets are sometimes called Rainbow tables.

Hash-based passphrase enhancements can be further improved using a salt. A salt is a value (e.g., “123” or “MySalt”) that serves as an additional input to passphrase-enhancing mechanism (e.g., a hash function). A salt can be randomly selected or pre-determined. As illustrated in FIG. 1B in accordance with certain embodiments, a salted hash function can take an original passphrase and a salt as inputs and generate a hash as an input. The output hash can serve as an enhanced passphrase, which can be used as the key for encryption/decryption. An enhanced passphrase using a salt can depend on at least three factors: the original passphrase, the salt, and the hash function. A salted hash function can make a brute force attack more difficult and costly, since a rainbow table needs to be generated for each possible salt and the brute force attack needs to go through all rainbow tables.

Brute force attack through rainbow tables can still make passphrase-based encryption mechanisms vulnerable if a third-party has enough computing power and ample time to pre-generate a large number of rainbow tables. One mechanism to thwart the generation of a rainbow table is key stretching. Key stretching is a mechanism that increases the time to compute a hash (e.g., an enhanced key) from a key (e.g., a passphrase or an enhanced passphrase). Key stretching is useful for preventing brute force attacks or preventing the generation of rainbow tables because key stretching increases the required amount of time to perform the brute force attacks or to generate rainbow tables.

Key stretching can involve applying a key stretching module to a key (e.g., a passphrase or an enhanced passphrase.) The key stretching module can be subjected to two design criteria. The first design criterion is the computation time. The computation time of the key stretching module should be long enough so that a third party cannot compute the key stretching module numerous times to find the correct passphrase. At the same time, the computation time of the key stretching module should not be so excessive such that the computation delay is noticeable to users. In some embodiments, the computation time of the key stretching module is designed to be about one second. The second design criterion is the prevention of shortcuts. The key stretching module should not allow any shortcuts that could compute the hash in less time than the key stretching module.

In some embodiments, a key stretching module can include multiple concatenated hash functions. For example, as illustrated in FIG. 1C in accordance with certain embodiments, a key stretching module can execute routines to run a single hash function a number of iterations. The key stretching module can sometimes be fixed and cannot be changed within a particular computing system. One way to do so is to fix the predetermined number of iterations, also called the iteration count. For example, the iteration count for iOS 3 is 2,000; the iteration count for iOS 4 is 10,000; the iteration count for Wi-Fi Protected Access (WPA) 2 is 4,096; and the iteration count for BlackBerry OS has been one until a recent update. The fixed iteration count can pose security threats. Because the iteration count is identical on all the machines running the same computing platform and sometimes well-known, a third party can generate a single rainbow table to access all the data in all the machines running the same computing platform. For example, if a third party would like to access multiple encrypted files on iOS 3, the third party can generate a single rainbow table using the iteration count 2,000, and use the same rainbow table to quickly identify the passphrase for all encrypted files on iOS 3. Because a single rainbow table could be used to breach many files, a third party has enough motivation to generate the rainbow table, even if that takes a long time due to key stretching.

Key stretching mechanisms can be enhanced by a technique called dynamic key stretching. Dynamic key stretching is a mechanism for varying the iteration count of a key stretching module. Varying the iteration count of a key stretching module can address deficiencies associated with the traditional fixed-iteration key stretching mechanisms. For example, varying the iteration count of a key stretching module can provide a protection against rainbow tables which are generally tailored to a particular iteration count. Therefore a single rainbow table cannot be used to breach two files associated with two different iteration counts. If two files are encrypted using key stretching modules of different iteration counts, a third party cannot use a single rainbow table to breach both files.

Because a single rainbow table cannot be used, a third party attempting to breach an encryption mechanism with dynamic key stretching can only resort to one of two methods, neither of which is appealing. In the first method, the third party can maintain and use multiple rainbow tables, each of which is tailored to one of different candidate iteration counts. This method is not appealing because rainbow tables are often extremely large and consume a lot of data storage space. In the second method, the third party can determine the iteration count associated with an encrypted file and subsequently generate a rainbow table for the determined iteration count. This method is also not appealing because the rainbow table needs to be generated on-the-fly, which can incur a lot of computation time and overhead. Therefore, varying the iteration count of a key stretching module can provide a protection against rainbow tables.

An enhanced passphrase is sometimes called a key, which is usually a very large number that is extremely difficult to guess. To assist validating the integrity of a key, another value (i.e., a check value) can sometimes be derived from the key. One example of such derived values is a checksum. A checksum (a.k.a. hash sum) is generally a fixed-size datum computed from an arbitrary block of digital data. The integrity of the data can be checked at a later time by re-computing the checksum and comparing it with the stored one. If the checksums match, the data were most likely not altered. A checksum of a key can serve as a check value for the key. The generation of a check value from a key can sometimes take a salt as an additional input for enhanced security. A key and its check value can be in many formats. For example, a key can be a 256-bit value; a check value for the key can be a 4-byte or 8-byte value. Sometimes, a check value can be converted and presented in a human readable format for convenience. One example of such human readable formats is an ASCII Hex value (e.g., “ABCD1234”).

Existing systems usually require the entire encrypted file to be available before decryption takes place. Sometimes decryption routines on existing systems may not indicate decryption failure even if the passphrase is incorrect and the decrypted data is garbage. The decryption process can be computation-intensive and therefore take substantial time to finish. In addition, downloading remote files can be time-consuming and costly. If a user enters an incorrect passphrase, an existing system may not inform the user of the passphrase failure until it downloads the entire file and decrypts the downloaded file using the incorrect passphrase. Ideally, the system should inform the user that he/she has entered an incorrect passphrase before completing the time-consuming and costly downloading and/or decryption process. The subject matter disclosed herein provides systems and methods of storing and verifying security information (e.g., passphrase) more efficiently. In some embodiments, a check value of the passphrase is stored in a file header of the target file. When verifying the passphrase, the target file does not need to be completely available. When the target file is stored remotely, only a small portion (e.g., the header) of the file needs to be downloaded from the remote end. In some other embodiments, a check value of the passphrase is stored in a metadata of the target file. When verifying the passphrase, the target file itself does not need to be available. When the target file is stored remotely, the file does not need to be downloaded from the remote end at all. In some other embodiments, an ASCII Hex value of the check value is stored in the filename of the target file. When verifying the passphrase, the target file itself does not need to be accessed. When the target file is stored remotely, the file does not need to be downloaded from the remote end at all. In these embodiments in accordance with the disclosed subject matter, the security information (e.g., passphrase) can be verified before the entire file becomes available—thus saving time and resources.

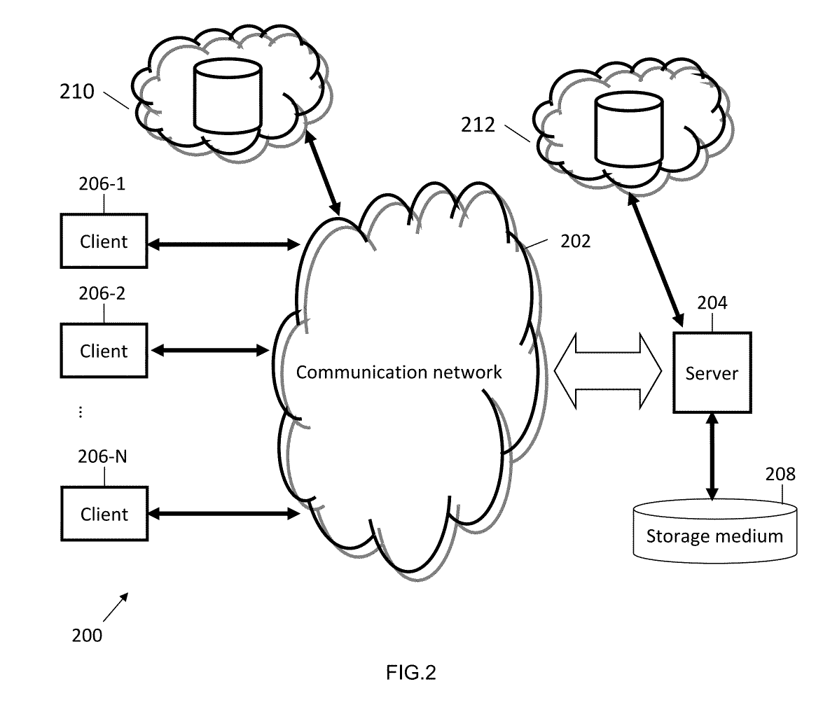

The disclosed subject matter can be implemented in a local and/or networked computing system. FIG. 2 illustrates a diagram of a networked communication arrangement 200 in accordance with an embodiment of the disclosed subject matter. The networked communication arrangement 200 can include a communication network 202, a server 204, and at least one client 206 (e.g., client 206-1, 206-2, . . . 206-N), a physical storage medium 208, and a cloud storage 210 and 212.

Each client 206 can communicate with the server 204 to send data to, and to receive data from, the server 204 across the communication network 202. Although FIG. 2 shows each client 206 being directly coupled to the server 204, each client 206 can be connected to server 204 via any other suitable device, communication network, or combination thereof For example, each client 206 can be coupled to the server 204 via one or more routers, switches, access points, and/or communication network (as described below in connection with communication network 202). A client 206 can include a desktop computer, a mobile computer, a tablet computer, a cellular device, or any computing systems that are capable of performing computation.

Server 204 is coupled to at least one physical storage medium 208, which is configured to store data for the server 204. Any client 206 can store data in, and access data from, the physical storage medium 208 via the server 204. FIG. 2 shows the server 204 and the physical storage medium 208 as separate components; however, the server 204 and physical storage medium 208 can be combined together. FIG. 2 also shows the server 204 as a single server; however, server 204 can include more than one server. FIG. 2 shows the physical storage medium 208 as a single physical storage medium; however, physical storage medium 208 can include more than one physical storage medium. The physical storage medium 208 can be located in the same physical location as the server 204, at a remote location, or any other suitable location or combination of locations.

FIG. 2 shows two embodiments of a cloud storage 210 and 212. Cloud storage 210 and/or 212 can store data from physical storage medium 208 with the same restrictions, security measures, authentication measures, policies, and other features associated with the physical storage medium 208. FIG. 2 shows the cloud storage 212 separate from the communication network 202; however, cloud storage 212 can be part of communication network 202 or another communication network. The server 204 can use only cloud storage 210, only cloud storage 212, or both cloud storages 210 and 212. FIG. 2 shows one cloud storage 210 and one cloud storage 212; however, more than one cloud storage 210, more than one cloud storage 212 or any suitable combination thereof can be used.

The communication network 202 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 2 shows the network 202 as a single network; however, the network 202 can include multiple interconnected networks listed above.

In some embodiments, the encryption mechanism can be implemented in the client 206 or the server 204 in an independent manner. For example, a client 206 can include both an encryption module and a decryption module, and the client 206 can locally perform the encryption and decryption of files. In other embodiments, the encryption mechanism can be implemented in a distributed manner. For example, a client 206 can encrypt data using its encryption module, and a server 204 can decrypt the encrypted data using its decryption module. In certain embodiments, the encryption mechanism can be implemented in a centralized manner at a server 204. For example, a client 206 can provide an encryption key or a decryption key to the server 204, and the server 204 uses its encryption or decryption module and the received encryption key or the decryption key to encrypt or decrypt the file.

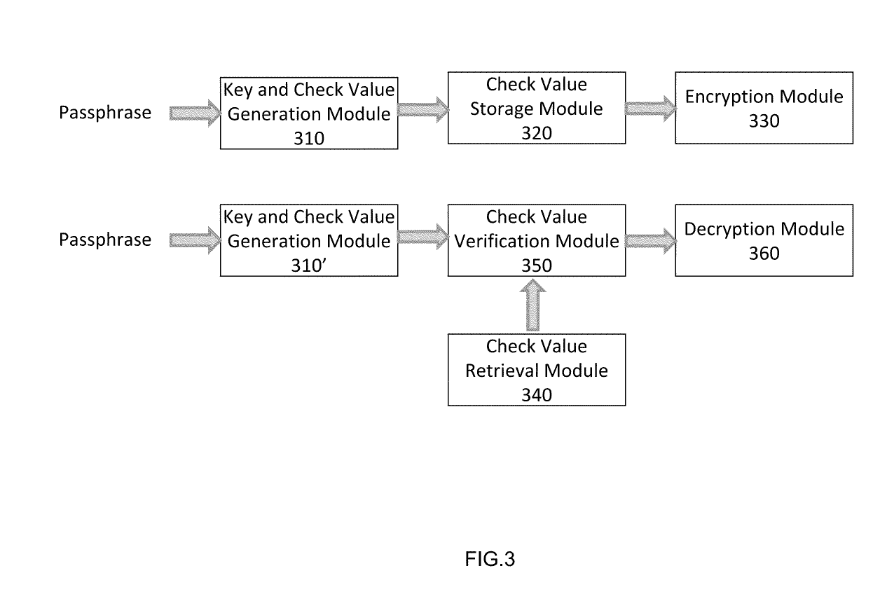

FIG. 3 illustrates a block diagram of a security information storage and verification system in accordance with certain embodiments of the disclosed subject matter. The security information storage and verification system can be implemented using one or more key and check value generation modules 310 and 310′, a check value storage module 320, an encryption module 330, a check value retrieval module 340, a check value verification module 350, and a decryption module 360. In some embodiments, a security information storage and verification system can be implemented in the client 206 or the server 204 in an independent manner. For example, a client 206 or a server 204 can itself include all the modules of a security information storage and verification system and can locally perform all the functionalities. In other embodiments, security information storage and verification system can be implemented in a distributed manner. For example, a client 206-1 can contain a key and check value generation module 310, a check value storage module 320, and an encryption module 330, while another client 206-2 or a server 204 can contain a key and check value generation module 310′, a check value retrieval module 340, a check value verification module 350, and a decryption module 360. In some other embodiments, the system can be implemented in a centralized manner in the arrangement 200. For example, a client 206 can provide a passphrase (or a key or its check value) to the server 204, and the server 204 uses its encryption or decryption module to encrypt or decrypt the file. As another example, one client 206-1 contains a key and check value generation module 310, a check value storage module 320, and an encryption module 330, while another client 206-2 or a server 204 can contain a key and check value generation module 310′, a check value retrieval module 340, a check value verification module 350, and a decryption module 360. As another example, all modules can be distributed across multiple clients/servers.

At the beginning of an example encryption process, the key and check value generation module 310 can receive security information for encrypting a certain file, data, or resource. One form of such security information is a passphrase (e.g., “MyPassphrase”) for encryption. The security information can be provided by a user of the computing system or by the computing system itself The security data can be received locally at the computing system or remotely from another computing system. Once the security information (e.g., a passphrase) is received, the key and check value generation module 310 can generate a key (i.e., an enhanced passphrase) from the received passphrase. The format and/or the size of the key can be pre-defined, such as 256 bits. The key generation can be via any suitable hash functions or key stretching mechanisms. The key generation can be with or without a salt. The salt can be randomly selected or predetermined. The salt used during key generation can be saved in the file, data, or resource to be encrypted itself or in a data structure associated with the file, data, resource.

Once the key is generated, a check value for the key can be further generated. A check value (e.g., “a+sdf3i$%j@*˜$%&*#%̂”) can be in the form of a checksum of the key. The format and/or the size of the check value can be pre-defined, such as 4 bytes or 8 bytes. The check value generation can use any suitable hash or checksum functions. The check value generation can be with or without a salt. The salt can be randomly selected or predetermined, and can be the same or different from the salt used for key generation. The salt used during check value generation can be saved in the file, data, or resource to be encrypted itself or in a data structure associated with the file, data, resource. The check value (or a portion thereof) can also be converted and presented in a representation that is in a human readable format for convenience. One example of such a human readable presentation is an ASCII Hex value (e.g., “ABCD1234”) of a check value. The size of an ASCII Hex value of a check value can be pre-determined, e.g., 8 bytes.

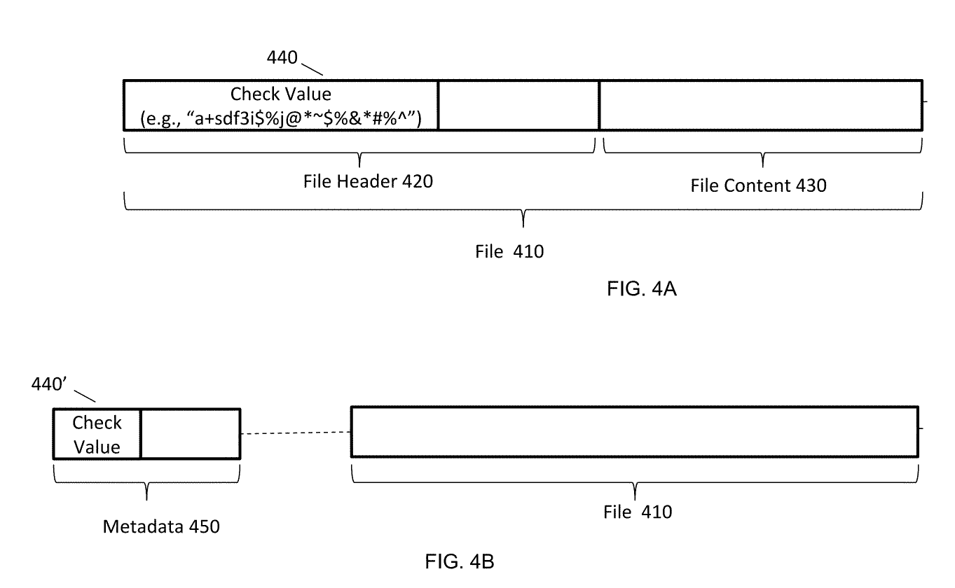

Once the check value and/or its representation is generated by the key and check value generation module 310, the check value and/or its representation can be passed into the check value storage module 320. The check value storage module 320 can store the entire check value or a portion of the check value with the target data, file, or resource. The size of the portion of the check value to be stored can be pre-determined or configurable. For example, in some embodiments, only four bytes of the check value can be selected to be stored; the four bytes can be selected from the beginning, the end, another segment, or a combination of segments of the check value. In some embodiments, the check value (or a portion thereof) can be stored inside the target file, data, or resource itself For example, as illustrated in FIG. 4A, a file 410 can contain a file header 420 and a file content 430. The check value (or a portion thereof) 440 can be stored inside a file header 440 of the target file 410. In other embodiments, the check value (or a portion thereof) can be stored in a separate data structure associated with the target file, data, or resource. For example, as illustrated in FIG. 4B, the file 410 can have a metadata 450 associated with the file 410. The check value (or a portion thereof) 440′ can be saved in the metadata 450 of the target file 410.

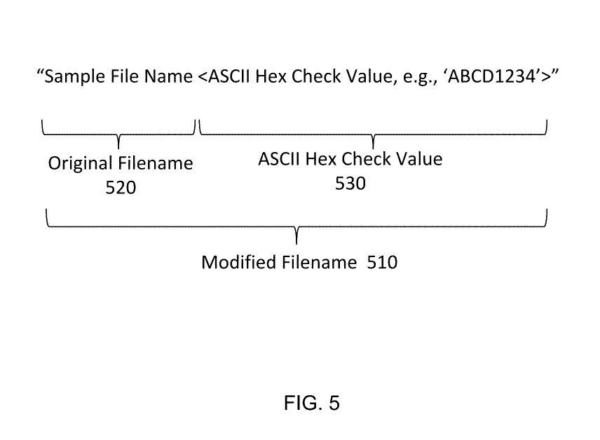

The check value storage module 320 can also store a representation of the check value in an identification of the target file, data, or structure. As discussed above, one example of such a representation is a human readable ASCII Hex value (e.g., “ABCD1234”) of a check value. The size of an ASCII Hex value of a check value can be pre-determined or configured, e.g., 8 bytes. Sometimes, only a portion of the ASCII Hex value of a check value is selected to be stored. The identification can be any data structure, reference, or identifier that can be used to identify the target file, data, or resource. For example, as illustrated in FIG. 5, a file can have an original file name 520. An identification 530 can be added to the original file name 520 to form a modified filename 510. When the representation of the check value (e.g., an 8-byte ASCII Hex value) is stored in a filename, the representation 530 of the check value can be visible or invisible to the user. For example, an ASCII Hex value can be stored in a filename in a way that the ASCII Hex value can be removed from the filename when the filename is displayed to the user. In this way, the storage of representation of the check value in the filename can be transparent to end users.

Once the check value and/or its representation are stored, the encryption module 330 can start encrypting the target file, data, or resource using the key. In some embodiments, encryption can occur after the check value and/or its representation are generated by the key and check value generation module 310 but before they are stored by the check value storage module 320.

At the beginning of an example decryption process, the key and check value generation module 310′ can receive security information for decrypting a certain file, data, or resource. As discussed above, one form of such security information is a passphrase (e.g., “MyPassphrase”) for encryption. The security information can be provided by a user of the computing system or by the computing system itself. The security data can be received locally at the computing system or remotely from another computing system. Once the security information (e.g., a passphrase) is received, the key and check value generation module 310′ can generate a key (i.e., an enhanced passphrase) from the received passphrase. The format and/or the size of the key can be pre-defined, such as 256 bits. The key generation can be via any suitable hash functions or key stretching mechanisms. The key generation can be with or without a salt. The salt can be randomly selected or predetermined. The salt used during key generation can be saved in the file, data, or resource to be encrypted itself or in a data structure associated with the file, data, resource. As discussed above for the key and check value generation module 310 during the encryption process, a check value for the key can be further generated from the key via any suitable hash or checksum functions with or without a salt. Also as discussed above for the key and check value generation module 310 during the encryption process, a representation of the key value can also be generated. In some embodiments, the key and check value generation module 310′ can be the same module as the one 310 used in the encryption process; in other embodiments, the key and check value generation module 310′ can be distinct from the one 310 used in the encryption process.

In the meantime, a check value retrieval module 340 can retrieve the security information for the target file, data, or resource previously stored during the encryption process. In some embodiments, the check value (or a portion thereof) can be retrieved from the target file, data, or resource itself. For example, the previously stored check value can be retrieved from the header of a target file. In this case, the check value retrieval module 340 only needs to access the header portion of the target file. If the target file is stored remotely, only a portion (e.g., the header) of the target file needs to be downloaded from the remote end. During streaming download, the desired portion of the target file can be downloaded and further processed (e.g., verifying security information) before the entire file is downloaded from the remote end. In other embodiments, the check value (or a portion thereof) can be retrieved from a separate data structure associated with the target file, data, or resource. For example, the check value (or a portion thereof) can be retrieved from a metadata of the target file. In this case, the check value retrieval module 340 only needs to access the metadata of the target file. The target file itself is not needed for verifying security information. If the target file is stored remotely, it does not need to be downloaded from the remote end at all. In some other embodiments, a representation of the check value can be retrieved from an identification of the target file, data, or resource. For example, an ASCII Hex value can be retrieved from the filename of a target file. In this case, the check value retrieval module 340 only needs to access the filename of the target file. The target file itself is not needed for verifying security information. If the target file is stored remotely, it does not need to be downloaded from the remote end at all.

The key and check value generation module 310′ and the key value retrieval module 340 can operate consecutively in any order or concurrently. Once the check value (or a portion thereof) and/or the representation of the check value generated by the key and check value generation module 310′ and their counterpart(s) retrieved by the check value retrieval module 340 are available, both can be forwarded to the check value verification module 350 for verification. The check value verification module 350 can compare the two inputs and determine if they match. If the two inputs match, this means that the security information (e.g., passphrase) received for decryption matches the security information (e.g., passphrase) previously stored during encryption. The verified security information can then be forwarded to the decryption module 360 to perform decryption. If the two inputs do not match, this means that the security information (e.g., passphrase) received for decryption does not match the security information (e.g., passphrase) previously stored during encryption. The decryption process can then be aborted. A warning or error message can then be displayed or recorded.

The disclosed decryption process avoids the lengthy and costly decryption process if the security information received for decryption is incorrect. The decryption process further avoids and/or shortens the lengthy and costly downloading process if the security information received for decryption is incorrect.

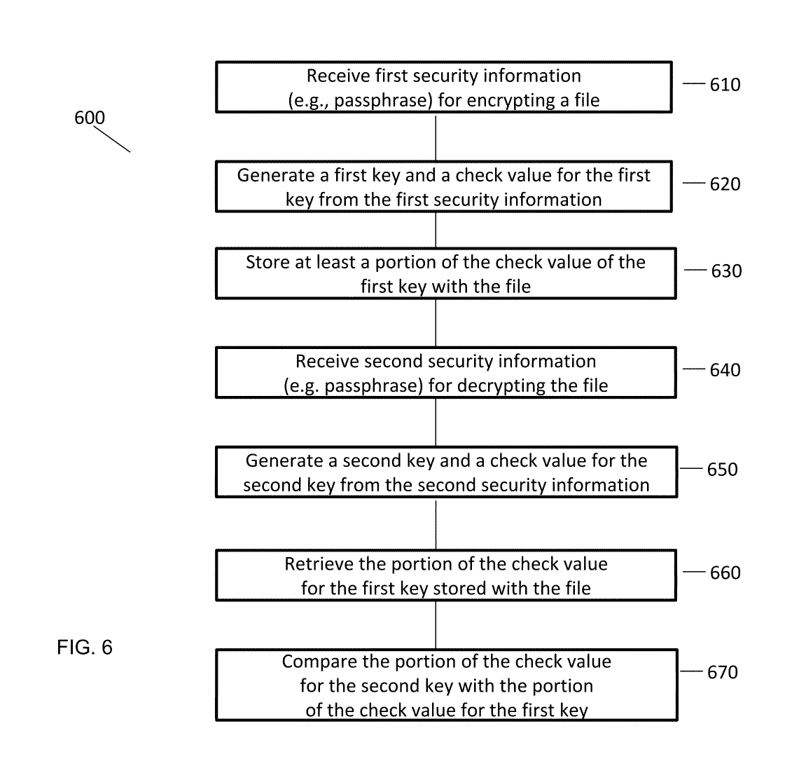

FIG. 6 illustrates one process of storing and verifying security information in accordance with certain embodiments of the disclosed subject matter. The process 600 can include more or less steps as illustrated in FIG. 6. The steps in the process 600 can be executed in the same or different sequences as illustrated in FIG. 6.

At step 610, the key and check value generation module 310 receives first security information for encrypting a certain file, data, or resource. One form of such first security information is a passphrase (e.g., “MyPassphrase”) for encryption. The first security information can be provided by a user of the computing system or by the computing system itself. The first security information can be received locally at the computing system or remotely from another computing system.

At step 620, the key and check value generation module 310 generates a first key (i.e., an enhanced passphrase) and a check value for the first key from the received first security information. The format and/or the size of the first key can be pre-defined, such as 256 bits. The first key can be generated via any suitable hash functions or key stretching mechanisms, with or without a salt. The salt can be randomly selected or predetermined. The salt used during key generation can be saved in the file, data, or resource to be encrypted itself or in a data structure associated with the file, data, resource.

Once the first key is generated, a check value for the first key can be further generated. The format and/or the size of the check value can be pre-defined, such as 4 bytes or 8 bytes. The check value can be generated via any suitable hash or checksum functions with or without a salt. The salt can be randomly selected or predetermined, and can be the same or different from the salt used for key generation. The salt used during check value generation can be saved in the file, data, or resource to be encrypted itself or in a data structure associated with the file, data, resource. Sometimes, a check value (or a portion thereof) can also be converted and presented in a representation that is in a human readable format for convenience. One example of such a human readable presentation is an ASCII Hex value (e.g., “ABCD1234”) of a check value. The size of an ASCII Hex value of a check value can be pre-determined, e.g., 8 bytes.

At step 630, the check value storage module 320 stores the generated check value for the first key or a portion thereof. The check value storage module 320 can store at least a portion of the check value with the target data, file, or resource. The size of the portion of the check value to be stored can be pre-determined or configurable. For example, in some embodiments, only four bytes of the check value are selected to be stored; the four bytes can be selected from the beginning, the end, another segment, or a combination of segments of the check value. In some embodiments, the check value (or a portion thereof) can be stored inside the target file, data, or resource itself, for example, as shown and described in connection with FIGS. 4A and 4B.

At step 640, the key and check value generation module 310′ receives second security information for decrypting a certain file, data, or resource. One form of such second security information is a passphrase (e.g., “MyPassphrase”) for encryption. The second security information can be provided by a user of the computing system or by the computing system itself. The second security data can be received locally at the computing system or remotely from another computing system.

At step 650, the key and check value generation module 310′ generates a second key (i.e., an enhanced passphrase) and a check value for the second key from the received second security information. The format and/or the size of the second key can be pre-defined, such as 256 bits. The second key can be generated via any suitable hash functions or key stretching mechanisms with or without a salt. The salt can be randomly selected or predetermined. In some embodiments, the key generation mechanism and/or salt used at step 650 is the same as the key generation mechanism and/or salt used at step 620. The salt for key generation at step 650 can be retrieved from the target file, data, or resource itself or in a data structure associated with the target file, data, resource. As discussed above for the key and check value generation module 310 during the encryption process, a check value for the second key can be further generated from the second key via any suitable hash or checksum functions with or without a salt. In some embodiments, the check value generation mechanism and/or salt used at step 650 is the same as the check value generation mechanism and/or salt used at step 620. The salt for check value generation at step 650 can be retrieved from the target file, data, or resource itself or in a data structure associated with the target file, data, resource.

At step 660, the check value retrieval module 340 retrieves the portion of the check value for the first key previously stored during encryption at step 630. In some embodiments, the check value (or a portion thereof) can be retrieved from the target file, data, or resource itself. For example, the previously stored check value can be retrieved from the header of a target file. In this case, the check value retrieval module 340 only needs to access the header portion of the target file. If the target file is stored remotely, only a portion (e.g., the header) of the target file needs to be downloaded from the remote end. During streaming download, the desired portion of the target file can be downloaded and further processed (e.g., verifying security information) before the entire file is downloaded from the remote end. In other embodiments, the check value (or a portion thereof) can be retrieved from a separate data structure associated with the target file, data, or resource. For example, the check value (or a portion thereof) can be retrieved from a metadata of the target file. In this case, the check value retrieval module 340 only needs to access the metadata of the target file. The target file itself is not needed for verifying security information. If the target file is stored remotely, it does not need to be downloaded from the remote end at all.

At step 670, the check value verification module 350 compares the portion of the check value for the second key with the retrieved portion of the check value for the first key. The check value verification module 350 can compare the two inputs and determine if they match. If the two inputs match, this means that the security information (e.g., passphrase) received for decryption at step 640 matches the security information (e.g., passphrase) previously stored during encryption at 630. The verified security information can then be forwarded to the decryption module 360 to perform decryption. If the two inputs do not match, this means that the security information (e.g., passphrase) received for decryption does not match the security information (e.g., passphrase) previously stored during encryption. The decryption process can then be aborted. A warning or error message can then be displayed or recorded.

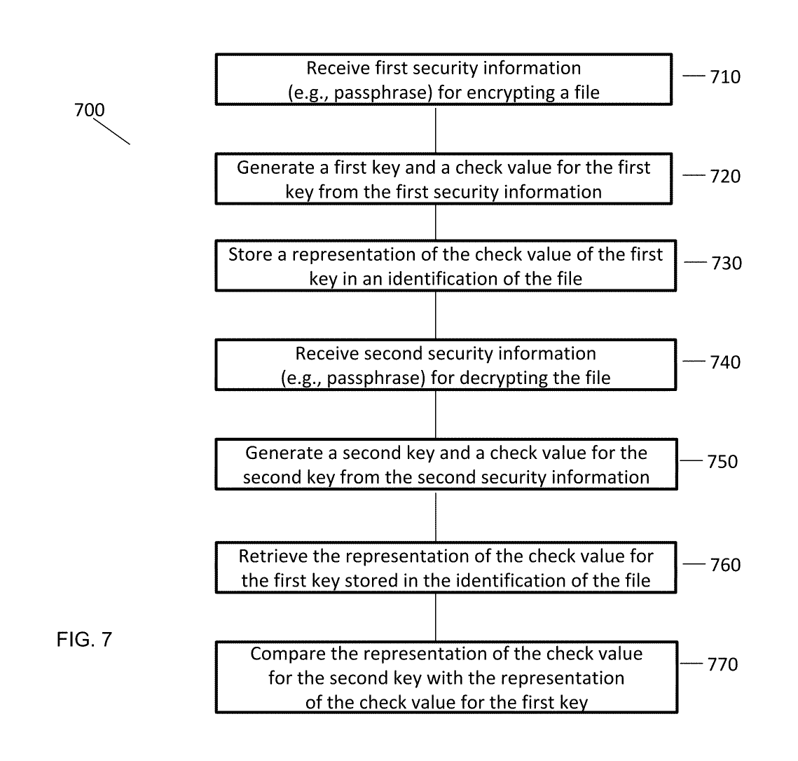

FIG. 7 illustrates another process of storing and verifying security information in accordance with certain embodiments of the disclosed subject matter. The process 700 can include more or less steps as illustrated in FIG. 7. The steps in the process 700 can be executed in the same or different sequences as illustrated in FIG. 7.

At step 710, the key and check value generation module 710 receives first security information for encrypting a certain file, data, or resource. One form of such first security information is a passphrase (e.g., “MyPassphrase”) for encryption. The first security information can be provided by a user of the computing system or by the computing system itself. The first security information can be received locally at the computing system or remotely from another computing system.

At step 720, the key and check value generation module 710 generates a first key (i.e., an enhanced passphrase) and a check value for the first key from the received first security information. The format and/or the size of the first key can be pre-defined, such as 256 bits. The first key can be generated via any suitable hash functions or key stretching mechanisms with or without a salt. The salt can be randomly selected or predetermined. The salt used during key generation can be saved in the file, data, or resource to be encrypted itself or in a data structure associated with the file, data, resource.

Once the first key is generated, a check value for the first key can be further generated. The format and/or the size of the check value can be pre-defined, such as 4 bytes or 8 bytes. The check value can be generated via any suitable hash or checksum functions with or without a salt. The salt can be randomly selected or predetermined, and can be same or different from the salt used for key generation. The salt used during check value generation can be saved in the file, data, or resource to be encrypted itself or in a data structure associated with the file, data, resource. Sometimes, a check value (or a portion thereof) can also be converted and presented in a representation that is in a human readable format for convenience. One example of such a human readable presentation is an ASCII Hex value (e.g., “ABCD1234”) of a check value. The size of an ASCII Hex value of a check value can be pre-determined, e.g., 8 bytes.

At step 730, the check value storage module 320 stores a representation of the generated check value for the first key in an identification of the target file, data, or structure. One example of such a representation is a human readable ASCII Hex value (e.g., “ABCD1234”) of a check value. The size of an ASCII Hex value of a check value can be pre-determined or configured, e.g., 8 bytes. Sometimes, only a portion of the ASCII Hex value of a check value is selected to be stored. The identification can be any data structure, reference, or identifier that can be used to identify the garget of the target file, data, or resource, for example, as shown and described in connection with FIG. 5.

At step 740, the key and check value generation module 310′ receives second security information for decrypting a certain file, data, or resource. One form of such second security information is a passphrase (e.g., “MyPassphrase”) for encryption. The second security information can be provided by a user of the computing system or by the computing system itself. The second security data can be received locally at the computing system or remotely from another computing system.

At step 750, the key and check value generation module 310′ generates a second key (i.e., an enhanced passphrase) and a check value for the second key from the received second security information. The format and/or the size of the second key can be pre-defined, such as 256 bits. The second key can be generated via any suitable hash functions or key stretching mechanisms with or without a salt. The salt can be randomly selected or predetermined. In some embodiments, the key generation mechanism and/or salt used at step 750 is the same as the key generation mechanism and/or salt used at step 720. The salt for key generation at step 750 can be retrieved from the target file, data, or resource itself or in a data structure associated with the target file, data, resource. As discussed above for the key and check value generation module 310 during the encryption process, a check value for the second key can be further generated from the second key via any suitable hash or checksum functions with or without a salt. In some embodiments, the check value generation mechanism and/or salt used at step 750 is the same as the check value generation mechanism and/or salt used at step 720. The salt for check value generation at step 650 can be retrieved from the target file, data, or resource itself or in a data structure associated with the target file, data, resource.

At step 760, the check value retrieval module 340 retrieves the representation of the check value for the first key previously stored during encryption at step 730. A representation of the check value can be retrieved from an identification of the target file, data, or resource. For example, an ASCII Hex value can be retrieved from the filename of a target file. In this case, the check value retrieval module 340 only needs to access the filename of the target file. The target file itself is not needed for verifying security information. If the target file is stored remotely, it does not need to be downloaded from the remote end at all.

At step 770, the check value verification module 350 compares the representation of the check value for the second key with the retrieved representation of the check value for the first key. The check value verification module 350 can compare the two inputs and determine if they match. If the two inputs match, this means that the security information (e.g., passphrase) received for decryption at step 740 matches the security information (e.g., passphrase) previously stored during encryption at 730. The verified security information can then be forwarded to the decryption module 360 to perform decryption. If the two inputs do not match, this means that the security information (e.g., passphrase) received for decryption does not match the security information (e.g., passphrase) previously stored during encryption. The decryption process can then be aborted. A warning or error message can then be displayed or recorded.

The steps in processes 600 and 700 can be performed on one local computing system, on one or more remote computing systems, or on a combination of local and remote computing systems. For one example, a computing system can receive security information for encryption and generate a key and check value locally, and then transmit the check value to a remote computing system that handles the storing steps. As another example, a computing system can receive security information for decryption and generate a key and check value locally, and then transmit the check value to a remote computing system that handles the verifying steps.

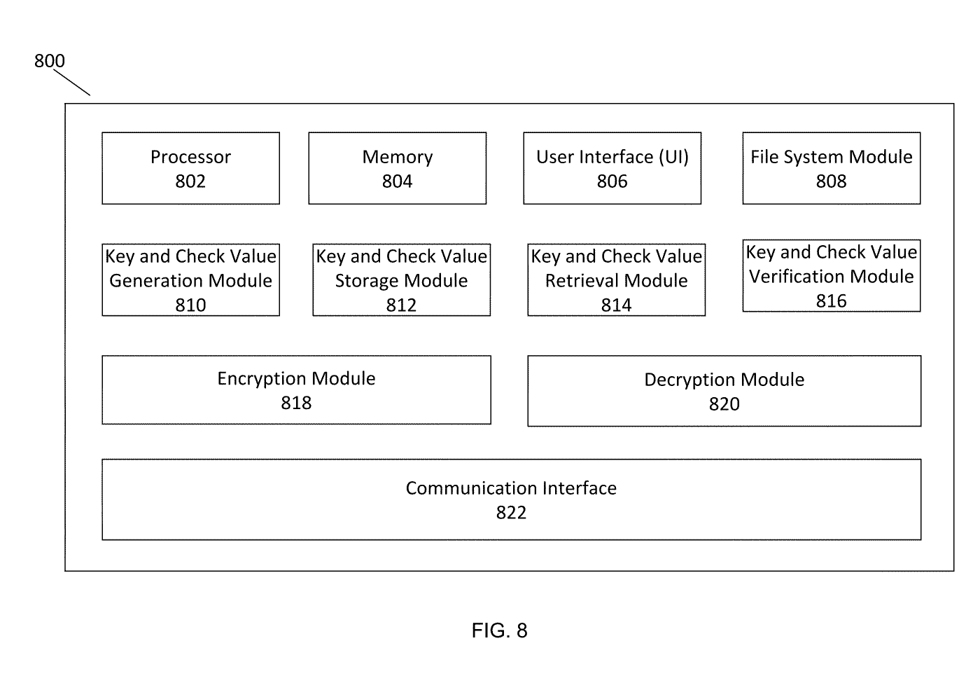

FIG. 8 illustrates a block diagram of a computing system in accordance with certain embodiments of the disclosed subject matter. The computing system 800 can serve as a client 206, a server 204, or both in the communication arrangement 200. The computing system 800 can include at least one processor 802 and at least one memory 804. The processor 802 can be either software or hardware or a combination. The processor 802 can be a general processor or be an application specific hardware (e.g., an application specific integrated circuit (ASIC), programmable logic array (PLA), field programmable gate array (FPGA), or any other integrated circuit). The processor 802 can execute computer instructions or computer code to perform desired tasks. The memory 804 can be a transitory or non-transitory computer readable medium, such as flash memory, a magnetic disk drive, an optical drive, a programmable read-only memory (PROM), a read-only memory (ROM), or any other memory or combination of memories. The computing system 800 can also include a key and check value generation module 810, a key and check value storage module 812, a key and check value retrieval module 814, a key and check value verification module 816, an encryption module 818, and a decryption module 820, all of which can be implemented in software or hardware or a combination of both. The description of these modules and their functionalities can be found in the description of their counterparts in FIG. 3.

The computing system 800 can also include a user interface (UI) 806, a communication interface 822, and a file system module 808. The UI 806 can provide an interface for users to interact with the computing system 800 in order to provide and/or receive data to/from users. The communication interface 822 can allow the computing system 800 to communicate with external resources (e.g., a network or a remote client/server). The file system module 808 can be configured to maintain a list of all data files, including both local data files and remote data files, in every folder in a file system. The file system module 808 can also be configured to maintain a list of all remote files that have previously been downloaded. The file system module 808 can be further configured to coordinate with the memory 804 to store local data files, remote data files that have been downloaded from a remote server, information about the data files, such as metadata, and any other suitable information about the data files.

The key and check value generation module 810, the key and check value storage module 812, the key and check value retrieval module 814, the key and check value verification module 816, the encryption module 818, the decryption module 820, the UI 806, the communication interface 822, and the file system module 806 can be implemented in software or hardware or in a combination. They can be implemented as separate modules or as one or more indistinguishable modules. In some embodiments, the computer system 800 can include additional modules, fewer modules, or any other suitable combination of modules that perform any suitable operation or combination of operations.

The disclosed systems and methods, as illustrated by examples above, can improve the efficiency of storing and verifying security information (e.g., passphrase). In some embodiments, security information can be verified before a lengthy and costly downloading and/or decryption process finishes. In some embodiments, security information can be verified before any portion of the target data/file/resource itself is downloaded.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
receiving a request to access an encrypted file from a storage medium, wherein the request includes security information;
performing key stretching on the security information to compute a key associated with the security information;
computing a first check value associated with the key;
receiving at least one of a header, metadata, or filename of the encrypted file from the storage medium;
retrieving a second check value stored in the at least one of the header, metadata, or filename of the encrypted file;
comparing the first check value with the second check value; and
receiving the encrypted file from the storage medium only when the first check value matches the second check value.

2. The method of claim 1 wherein the security information is a passphrase.

3. The method of claim 1 further comprising:
adding a salt to the security information; and
performing the key stretching on the security information and the salt to compute the key associated with the security information.

4. The method of claim 1 further comprising adding a salt to the key to compute the first check value associated with the key.

5. The method of claim 1 wherein the second check value stored in the filename of the encrypted file is an ASCII representation of the second check value.

6. An apparatus comprising:
a processor; and
a memory, wherein the processor is configured to execute a module in the memory to:
receive a request to access an encrypted file from a storage medium, wherein the request includes security information;
perform key stretching on the security information to compute a key associated with the security information;
compute a first check value associated with the key;
receive at least one of a header, metadata, or filename of the encrypted file from the storage medium;
retrieve a second check value stored in the at least one of the header, metadata, or filename of the encrypted file;
compare the first check value with the second check value; and
receive the encrypted file from the storage medium only when the first check value matches the second check value.

7. The apparatus of claim 6 wherein the security information is a passphrase.

8. The apparatus of claim 6, wherein the processor is configured to execute the module in the memory further to:
add a salt to the security information; and
perform the key stretching on the security information and the salt to compute the key associated with the security information.

9. The apparatus of claim 6, wherein the processor is configured to execute the module in the memory further to:
add a salt to the key to compute the first check value associated with the key.

10. The apparatus of claim 6 wherein the second check value stored in the filename of the encrypted file is an ASCII representation of the second check value.

11. A non-transitory computer readable medium having executable instructions operable to cause an apparatus to:
receive a request to access an encrypted file from a storage medium, wherein the request includes security information;
perform key stretching on the security information to compute a key associated with the security information;
compute a first check value associated with the key;
receive at least one of a header, metadata, or filename of the encrypted file from the storage medium;
retrieve a second check value stored in the at least one of the header, metadata, or filename of the encrypted file;
compare the first check value with the second check value; and
receive the encrypted file from the storage medium only when the first check value matches the second check value.

12. The non-transitory computer readable medium of claim 11 wherein the security information is a passphrase.

13. The non-transitory computer readable medium of claim 11, wherein the executable instructions are further operable to cause the apparatus to:
add a salt to the security information; and
perform the key stretching on the security information and the salt to compute the key associated with the security information.

14. The non-transitory computer readable medium of claim 11, wherein the executable instructions are further operable to cause the apparatus to:
add a salt to the key to compute the first check value associated with the key.

15. The non-transitory computer readable medium of claim 11 wherein the second check value stored in the filename of the encrypted file is an ASCII representation of the second check value.
